(19) United States
(12) Patent Application Publication
(10) Pub. No.: US 2026/0302668 A1
(43) Pub. Date: Oct. 1, 2026

(54) HIGH-RELIABILITY CONNECTOR FOR INTERCONNECTION WITH FLEXIBLE CABLE

(71) Applicant: Amphenol Aorora Technology (Huizhou) Co., Ltd., Huizhou (CN)

(72) Inventors: Qi Han, Huizhou (CN); Xiaohong Zhu, Huizhou (CN); Hancheng Chen, Huizhou (CN); Koen Maddens, Hofstade (BE)

(73) Assignee: Amphenol Aorora Technology (Huizhou) Co., Ltd., Huizhou (CN)

(21) Appl. No.: 19/577,592

(22) Filed: Mar. 25, 2026

(30) Foreign Application Priority Data
Mar. 26, 2025 (CN) 202510366304.8

(51) Int. Cl. H01R 12/79; H01R 12/70; H01R 12/72; H01R 12/77; H01R 13/24; H01R 13/502

(52) U.S. Cl. CPC H01R 12/79; H01R 12/7023; H01R 12/7052; H01R 12/7082; H01R 12/727; H01R 12/774; H01R 13/24; H01R 13/502

(57) ABSTRACT

High-reliability connectors for interconnection with flexible cables. A system includes receptacle and plug connectors. The receptacle includes a housing with a tongue in a cavity, a first terminal with a first contact portion, and second terminals with second contact portions. The plug includes a housing with a slot, and an extension extending from a body into the slot. The extension is movable between a prelocked position and a locked position. The body has a slit for a flexible cable to extend therefrom into the slot. The flexible cable has contact pads to connect with respective second terminals. During insertion, the flexible cable engages the first contact portion such that the contact pads remain separated from the second contact portions. When the extension moves to the locked position, the flexible cable is pressed toward the tongue to establish electrical contact. Such a configuration prevents scratching and enables hot insertion and removal.

### CROSS-REFERENCE TO RELATED APPLICATIONS

This application claims priority to and the benefit of Chinese Patent Application No. 202510366304.8, filed on Mar. 26, 2025. The contents of this application are incorporated herein by reference in their entirety.

### TECHNICAL FIELD

This patent application relates generally to interconnection systems, such as those including electrical connectors, used to interconnect electronic assemblies.

### BACKGROUND

Electrical connectors are used in many electronic systems. It is generally easier and more cost effective to manufacture a system as separate electronic assemblies, which may be joined with electrical connectors. Electrical connectors may be used for interconnecting electronic assemblies so that the electronic assemblies may operate together as part of a system. Connectors, for example, may be mounted on printed circuit boards within two assemblies that are connected by mating the connectors. In other systems, it may be impractical to join two printed circuit boards by directly plugs on those printed circuit boards. For example, when the system is assembled, those printed circuit boards may be separated by too great a distance for a direct connection between connectors mounted to the printed circuit boards.

In some systems, connections between electronic assemblies may be made through cables. The cables may be terminated with connectors that mate with connectors mounted on a printed circuit board. In this way, connections between electronic assemblies may be made by plugging a connector that is part of a cable assembly into a board connector that is mounted to the printed circuit board. In other system architectures, a connector terminating a cable may be mated with another connector terminating another cable.

An example of a system in which assemblies are connected through cables is a modern automobile. For example, automotive vehicles include electronic control units (ECUs) for controlling various vehicle systems, such as the engine control unit, transmission control unit (TCUs), battery management system (BMS), cell sensing circuit (CSC), security systems, emissions control system, lighting control units, advanced driver assistance systems (ADAS), entertainment systems, navigation systems, and cameras. These electronic control units may be manufactured as separate assemblies. To simplify manufacture of an automobile, the assemblies may be connected via cables that are terminated with connectors that enable connections to mating board connectors terminating other cables or attached to printed circuit boards within the assemblies.

### SUMMARY

Aspects of the present disclosure relate to high-reliability connectors for interconnection with flexible cables.

Some embodiments relate to an electrical connector configured for a flexible cable. The electrical connector may comprise a housing comprising a top comprising a locking space, a spacer, and a slot between the top and the spacer; and an integral component comprising a body, an extension extending from the body into the slot of the housing and configured to press the flexible cable into contact with conductive elements of a mating connector, and a locking member extending from the body into the locking space of the top of the housing, the integral component capable of moving from a prelocked position to a locked position when the electrical connector is mated with the mating connector so as to restrain movements between the electrical connector and the mating connector.

Optionally, the body of the integral component comprises a slit aligned with the slot such that the flexible cable passes through the slit of the integral component into the slot of the housing.

Optionally, the extension is configured to secure the flexible cable between the extension and the spacer.

Optionally, the housing comprises a side having a limiting block protruding into the slot; the extension of the integral component comprises first and second protrusions protruding toward the side of the housing, and a gap between the first and second protrusions; and the integral component is configured to receive the limiting block of the housing in the gap at the prelocked position and to move past the limiting block in a mating direction at the locked position.

Optionally, the locking space is a first locking space; the locking member is a first locking member; the housing comprises a bottom comprising a second locking space (e.g., 611); and the electrical connector comprises a second locking member (e.g., 8) disposed in the second locking space and configured for restraining movements between the flexible cable (e.g., 300) and the housing.

Optionally, the slot between the top and the spacer is a first slot; and the housing comprises a second slot between the bottom (and the spacer and configured for receiving another flexible cable.

Optionally, the slit is a first slit aligned with the first slot; the body of the integral component comprises a second slit aligned with the second slot such that the another flexible cable passes through the second slit of the integral component into the second slot of the housing.

Optionally, the extension is a first extension extending from the body into the first slot of the housing; the integral component comprises a second extension extending from the body into the second slot of the housing; and the second extension is configured to secure the another flexible cable between the second extension and the spacer.

Optionally, the electrical connector comprises the flexible cable comprising an insertion portion disposed in the slot, the insertion portion comprising a reinforcing layer extending to a leading end, the reinforcing layer comprising a thinner portion, the insertion portion comprising one or more through holes extending in both the leading end and the thinner portion.

Optionally, the extension comprises a rib facing the top, and a groove adjacent the first and second protrusions, both the rib and the groove configured to engage the mating connector.

Some embodiments relate to an electrical connector for connecting with a flexible cable. The electrical connector may comprise a housing comprising a cavity and a tongue disposed in the cavity; one or more first terminals disposed in the tongue, each of the one or more first terminals comprising a first elastic arm and a first contact portion disposed on the first elastic arm; and a plurality of second terminals each comprising a second contact portion, wherein at rest states, the first contact portions of the one or more first terminals are disposed above the second contact portions of the plurality of second terminals such that the one or more first terminals engage the flexible cable prior to the plurality of second terminals.

Optionally, the tongue of the housing comprises one or more protruding portions offset from the first contact portions of the one or more first terminals such that the one or more protruding portions of the tongue of the housing engage the flexible cable prior to the one or more first terminals.

Optionally, the tongue of the housing comprises one or more first channels configured for receiving respective first terminals; and the one or more protruding portions are disposed at distal ends of respective first channels.

Optionally, at the rest states, the first elastic arms of the one or more first terminals abut respective protruding portions.

Optionally, the tongue comprises a plurality of second channels configured for receiving respective second terminals.

Some embodiments relate to a method of operating a flexible cable with respect to an electrical connector, the electrical connector comprising a tongue, one or more first terminals having first contact portions disposed above the tongue, and a plurality of second terminals having second contact portions disposed above the tongue and below the first contact portions of the one or more first terminals. The method may comprise engaging a leading end of the flexible cable with the first contact portions of the one or more first terminals such that contact pads of the flexible cable are separated from the second contact portions of the plurality of second terminals; and applying a pressing force to the flexible cable toward the tongue such that the contact pads of the flexible cable make contact with respective second contact portions of the plurality of second terminals.

Optionally, the method comprises engaging the leading end of the flexible cable with protruding portions of the tongue prior to engaging the leading end of the flexible cable with the first contact portions of the one or more first terminals to reduce risks of damaging the contact pads of the flexible cable.

Optionally, the method comprises inserting the flexible cable until the protruding portions enter into respective through holes of the flexible cable.

Optionally, the method comprises removing the pressing force from the flexible cable such that the one or more first terminals lift up the flexible cable to disconnect the contact pads of the flexible cable from the respective second contact portions of the plurality of second terminals.

Optionally, the method comprises engaging a locking member with the electrical connector while applying, via an extension integrated with the locking member, the pressing force to the flexible cable toward the tongue.

Some embodiments relate to a receptacle connector for connecting with a flexible cable. The receptacle connector may comprise a housing comprising a pair of sides oppositely arranged in a transverse direction, a bottom and a top oppositely arranged in a thickness direction, as well as a rear and a tongue, the bottom, the top, the sides and the rear collectively surrounding a cavity with an opening, the tongue disposed in the cavity, and the tongue comprising a protruding portion near the opening; a first terminal disposed in the tongue, the first terminal comprising a first elastic arm and a first contact portion disposed on the first elastic arm; and a second terminal disposed between the first terminals, the second terminal comprising a second contact portion, wherein: the tongue comprises a tongue surface, and distances from vertexes of the protruding portion, the first contact portion and the second contact portion to the tongue surface are respectively H₁, H₂, H₃ which satisfies the relationship: H₂≥H₁>H₃; the flexible cable is configured to be disposed in the receptacle connector via an extension; the flexible cable comprises an insertion portion comprising contact pads and a through hole; the insertion portion is configured to pass through the opening and to be disposed on the tongue after being lifted by the first contact portion; the extension is configured to be inserted into or removed from the cavity in a longitudinal direction, and to press the insertion portion against the first contact portion in the thickness direction; and the protruding portion is configured to pass into the through hole, and the second contact portion is configured to electrically connect with the contact pad.

Optionally, the tongue extends from the rear towards the opening; in the longitudinal direction, the tongue comprises a first channel configured for receiving the first terminal; and the protruding portion is disposed at an end of the first channel, the first contact portion is adjacent to the protruding portion and protrudes towards the top or the bottom in a manner elastically extending/retracting within the first channel.

Optionally, the first terminal further comprises a first fixing portion fixedly connected to the rear; the first elastic arm extends from the first fixing portion, initially bent once towards the tongue in the thickness direction, and then bent a second time towards the top or the bottom and when the flexible cable is not pressed in the thickness direction, an end of the first elastic arm abuts against a bottom of the protruding portion.

Optionally, the tongue further comprises a second channel configured for receiving the second terminal, the second channel disposed between the first channels; and the second terminal comprises a second fixing portion and a second elastic arm extending from the second fixing portion and bent; and the second contact portion is disposed on the second elastic arm, and the second contact portion protrudes towards the top or the bottom in a manner elastically extending/retracting within the second channel.

Some embodiments relate to a connector assembly. The connector assembly may comprise a receptacle connector described herein; and a plug connector configured to mate with receptacle connector, the flexible cable disposed in the plug connector, wherein the insertion portion comprises a reinforcing layer having a thinner portion.

Optionally, the thinner portion comprises a recess comprising a single notch, a plurality of independent notches, or a continuous notch penetrating the insertion portion in the transverse direction.

Optionally, the through hole is at least partially located at a leading end of the insertion portion, and at least partially located in the thinner portion.

Optionally, the plug connector comprises: a housing comprising a bottom and a top oppositely arranged in the thickness direction, a pair of sides oppositely arranged in the transverse direction, and a spacer, the sides and the spacer, together with the top or bottom, respectively surround to form a slot, the extension extending in the slot, the top and the bottom respectively comprising a first locking space and a second locking space; a first locking member pre-installed in the first locking space and configured for connecting with the top of the housing of the receptacle connector; and a second locking member which is inserted and installed in the second locking space along the thickness direction and configured for limiting the flexible cable the housing of the plug connector.

Optionally, the plug connector further comprises a body having a slit connected with the slot; and the flexible cable is configured to pass through the slit and be inserted into the slot.

Optionally, the extension, the first locking member, and the body form an integral component; and the extension and the first locking member extend from the same side of the body.

Optionally, the side of the housing of the plug connector comprises a limiting block protruding towards the slot, and the limiting block comprises a guiding portion and a stopping portion; and the extension comprises a first protrusion and a second protrusion protruding from a side wall, as well as a gap between the first protrusion and the second protrusion; and when the extension is pre-locked in the housing of the plug connector, the limiting block snaps into engagement with the gap, and the first protrusion is limited at the stopping portion.

Optionally, when the extension moves forward in the longitudinal direction and pushes the leading end of the flexible cable in the thickness direction to press the second contact portion, the second protrusion passes by the guiding portion and is finally limited at the stopping portion.

Optionally, the extension comprises a reinforcing rib facing the top or the bottom, and the reinforcing rib is connected to the body and extends in the longitudinal direction; the extension comprises a groove in the longitudinal direction at a position adjacent to the first protrusion and the second protrusion; and the top of the housing of the receptacle connector comprises a locking slot facing the cavity, and the first locking member is configured to move synchronously with the extension and is inserted and fixed in the locking slot.

These techniques may be used alone or in any suitable combination. The foregoing summaries are provided by way of illustration and are not intended to be limiting.

### BRIEF DESCRIPTION OF THE DRAWINGS

The accompanying drawings are not intended to be drawn to scale. In the drawings, identical or nearly identical components that are illustrated in various figures may be represented by a like numeral. For purposes of clarity, not every component may be labeled in every drawing. In the drawings:

FIG. 1 is a perspective view of an electronic system comprising a receptacle connector mounted on a board, according to some embodiments.

FIG. 2 is an exploded perspective view of the receptacle connector shown in FIG. 1.

FIG. 3 is a perspective view of flexible cables, according to some embodiments.

FIG. 4 is a cross-sectional perspective view of the receptacle connector shown in FIG. 1 taken along a line marked “A-A” in FIG. 2.

FIG. 5 is an enlarged perspective view of a portion of the receptacle connector shown in FIG. 1 within a box marked “B” in FIG. 4.

FIG. 6 is a cross-sectional view of the receptacle connector shown in FIG. 1 mating with a plug.

FIG. 7 is a cross-sectional view of the receptacle connector shown in FIG. 1 mated with a plug.

FIG. 8 is a perspective view of the electronic system of FIG. 1, showing a plug separated from the receptacle connector mounted on the board.

FIG. 9 is a perspective view of the electronic system of FIG. 8, showing the plug mated with the receptacle connector mounted on the board.

FIG. 10 is a partial cross-sectional view of the electronic system of FIG. 8, showing an insertion portion of a flexible cable lifted by a first contact portion of the receptacle connector shown in FIG. 1.

FIG. 11 is an exploded perspective view of the plug shown in FIG. 8.

FIG. 12 is a cross-sectional view of the electronic system of FIG. 8, taken along a line marked “C-C” in FIG. 8.

FIG. 13 is a cross-sectional view of the electronic system of FIG. 9, taken along a line marked “D-D” in FIG. 9.

FIG. 14 are cross-sectional views of the electronic system of FIG. 8, illustrating mating and unmating the connectors.

FIG. 15 is a cross-sectional view of the electronic system of FIG. 8, showing mated connectors.

Reference signs in the drawings: 100—receptacle connector; 1—housing, 2—first terminal, 3—second terminal, 4—board lock, 5—circuit board; 10—cavity, 11—side, 12—bottom, 13—top, 14—rear, 15—tongue, 16—opening; 111—board lock receiver, 131—locking slot, 151—protruding portion, 152—first channel, 153—second channel, 21—first elastic arm, 22—first contact portion, 23—first fixing portion; 31—second contact portion, 32—second fixing portion, 33—second elastic arm; 200—plug connector; 6—housing, 7—first locking member, 8—second locking member; 60—slot, 61—bottom, 62—top, 63—side, 64—spacer, 65—body; 621—first locking space, 622—guiding groove, 611—second locking space, 631—limiting block, 632—guiding portion, 633—stopping portion, 651—slit; 300—flexible cable; 301—insertion portion, 302—contact pad, 303—through hole, 304—reinforcing layer, 305—thinner portion, 306—leading end; 400—extension; 401—first protrusion, 402—second protrusion, 403—gap, 404—reinforcing rib, 405—groove; 500—integral component; X—transverse direction, Y—longitudinal direction, Z—thickness direction.

### DETAILED DESCRIPTION

The inventors have recognized and appreciated techniques for making high-reliability connectors for connecting flexible cables. Such connectors may be used in a harsh environment such as one presented by an automobile. For example, the connector may be used to connect a battery management system (BMS) and cell sensing circuit (CSC) in automobiles. The inventors have recognized and appreciated that terminals made according to conventional technology make contact with contact pads of a flexible cable during insertion and removal of the flexible cable from a receptacle connector, which may cause scratching and wear to the contact pads of the flexible cable, and may introduce foreign objects into the contact area during the process. Furthermore, conventional technology does not support hot insertion or removal.

Techniques describe herein enables contact pads of a flexible cable to establish electrical contact only after the flexible cable has been disposed in position. Such a configuration can prevent scratching or damage to the contact pads during insertion or removal and can support hot insertion and removal.

In some embodiments, during insertion, the insertion portion of the flexible cable may pass through the opening and is positioned on the tongue. The insertion portion may be guided forward by the protruding portion and lifted by the first contact portion having the greatest protruding portion height. After the insertion portion reaches the predetermined position, the extension may be inserted into the cavity and push the insertion portion in the thickness direction so that the insertion portion presses against the first contact portion. The protruding portion may engage a through hole to provide positioning, and the contact pad may abut against the second contact portion to establish electrical contact. As a result, the contact pad may contact the second terminal only after the flexible cable is disposed in position, thereby reducing scratching or wear of the plated contact pad during the insertion or removal process and reducing the likelihood of foreign objects entering the contact area.

In some embodiments, the receptacle connector and the plug connector may be cooperatively connected. The flexible cable may include a thinner portion that facilitates insertion into the cavity and assists lifting before being pressed by the extension. This configuration improves the stability of the connection between the flexible cable and the second terminal and enhances transmission efficiency.

In some embodiments, through the cooperation between the first terminal and the leading end of the flexible cable, when the extension is removed, the first contact portion may elastically lift the leading end in the thickness direction. This movement may separate the contact pad from the second contact portion, thereby enabling hot insertion and removal.

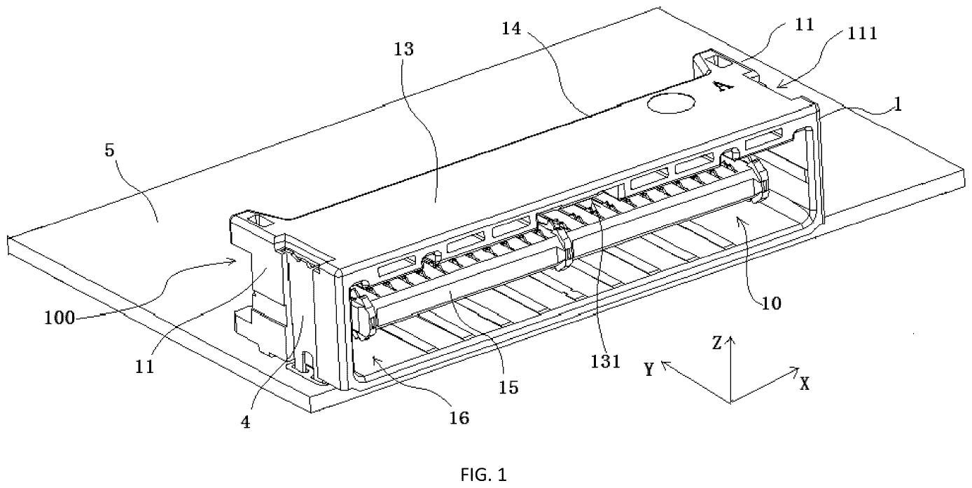

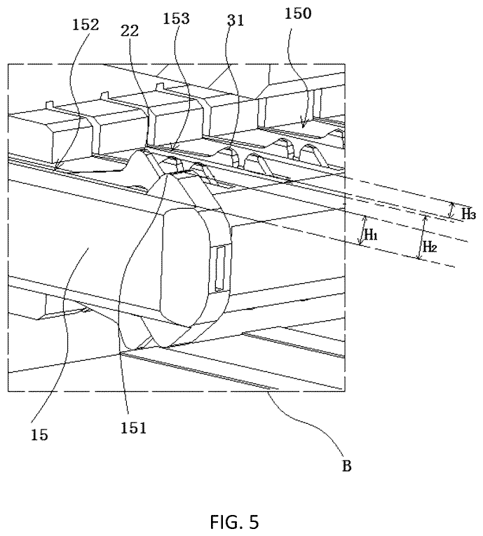

Referring to FIGS. 1-7, the present embodiment provides a receptacle connector 100 configured for connecting with a flexible cable 300. The receptacle connector 100 includes a housing 1, first terminals 2, and second terminals 3. The first terminals 2 and the second terminals 3 are installed in the housing 1. The housing 1 includes a pair of sides 11 oppositely arranged in a transverse direction X, a bottom 12 and a top 13 oppositely arranged in a thickness direction Z, as well as a rear 14 and a tongue 15. The bottom 12, the top 13, the rear 14, and sides 11 on the left and right sides collectively surround to form a cavity 10. The cavity 10 is provided with an opening 16. The opening 16 and the rear 14 are oppositely arranged in a longitudinal direction Y. The tongue 15 is disposed in the cavity 10, and the tongue 15 is provided with a protruding portion 151 near the opening 16.

The first terminals 2 are disposed in the tongue 15. Each first terminal 2 includes a first elastic arm 21 and a first contact portion 22 disposed on the first elastic arm 21.

The second terminals 3 are disposed between the first terminals 2 on both sides. Each second terminal 3 is provided with a second contact portion 31.

The tongue 15 is provided with a tongue surface 150, which is a flat surface. Distances from the vertexes of the protruding portion 151, the first contact portion 22, and the second contact portion 31 to the tongue surface 150 are H₁, H₂, ∧ H₃, respectively. H₁, H₂, ∧ H₃ satisfy the relationship: H₂≥H₁>H₃. H₁ is a distance from the vertex of the protruding portion to the tongue surface. H₂ is a distance from the vertex (contact point) of the first contact portion to the tongue surface. H₃ is a distance from the vertex (contact point) of the second contact portion to the tongue surface.

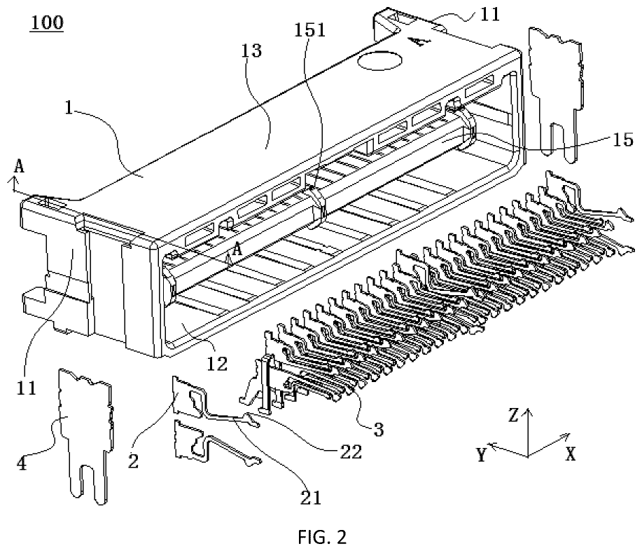

The flexible cable 300 is an FPC or FFC, which is installed in the receptacle connector 100 via an extension 400. As shown in FIG. 2, the flexible cable 300 includes an insertion portion 301, contact pads 302, and through holes 303. The contact pads 302 are metal plating layers arranged along the longitudinal direction Y, and the through holes 303 are avoidance holes. The contact pads 302 and through holes 303 are disposed on the insertion portion 301. The insertion portion 301 passes through the opening 16 and is installed on the tongue 15 after being lifted by the first contact portion 22. The extension 400 is inserted into or removed from the cavity 10 in the longitudinal direction Y, and the extension 400 presses the insertion portion 301 against the first contact portion 22 in the thickness direction Z. The protruding portion 151 passes into the through hole 303, and the second contact portion 31 electrically contacts and connects to the contact pad 302.

In the illustrated example, the flexible cable 300 is connected to the receptacle connector 100 through the insertion portion 301, with passing through the opening 16 into the cavity 10, and then guided by the protruding portion 151, which has an upwardly sloped curved surface structure, to the first contact portion 22 to be lifted. The distance H₂ from the vertex of the first contact portion 22 to the tongue surface is greater than the distance H₃ from the vertex of the second contact portion to the tongue surface, causing the leading end of the insertion portion 301 to be lifted. The contact pads 302 do not contact the second contact portion 31. As a result, the contact pads 302 do not scrape against the second contact portion 31 during the process of inserting the flexible cable 300 into the cavity 10, thus avoiding wear.

It can be understood that the relationship “H₂≥H₁>H₃” is present when the insertion portion 301 is not pressed against the first contact portion 22.

After the flexible cable 300 is installed in place, the extension 400 is inserted into the cavity 10 from the opening 16, pressing the insertion portion 301 against the first contact portion 22 in the thickness direction Z. In this case, the distance H₂ from the vertex of the first contact portion to the tongue surface decreases, and it may become H₂≥H₃.

The receptacle connector 100 of the present embodiment is a board-side connector, which is mounted on a rigid circuit board 5 via board locks 4. Specifically, the housing 1 is provided with board lock receivers 111 on the sides 11 on both sides. The board locks 4 pass through the board lock receivers 111 and are fixed to the circuit board 5 which is also known as a PCB.

As shown in FIG. 1, the receptacle connector 100 is provided with a locking slot 131 on the top 13 facing the cavity 10, for locking connection with the plug connector.

The tongue 15 extends from the rear 14 towards the opening 16, but an end of the tongue 15 does not extend to the opening 16. It can be understood that one end of the tongue 15 is connected to the rear 14, and the other end extends towards the opening 16 but maintains a certain distance from the opening 16, ensuring that the process of connecting the flexible cable to the first terminal and the second terminal occurs within the cavity 10.

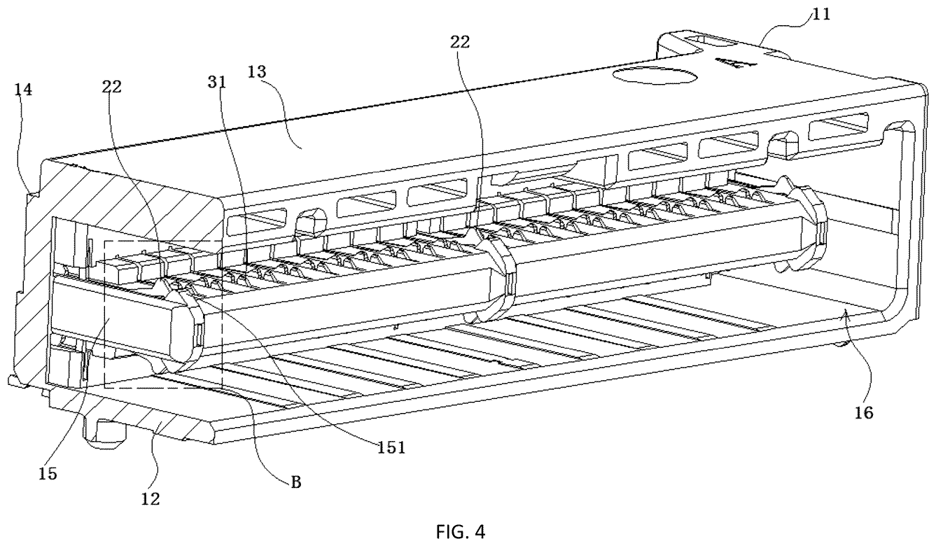

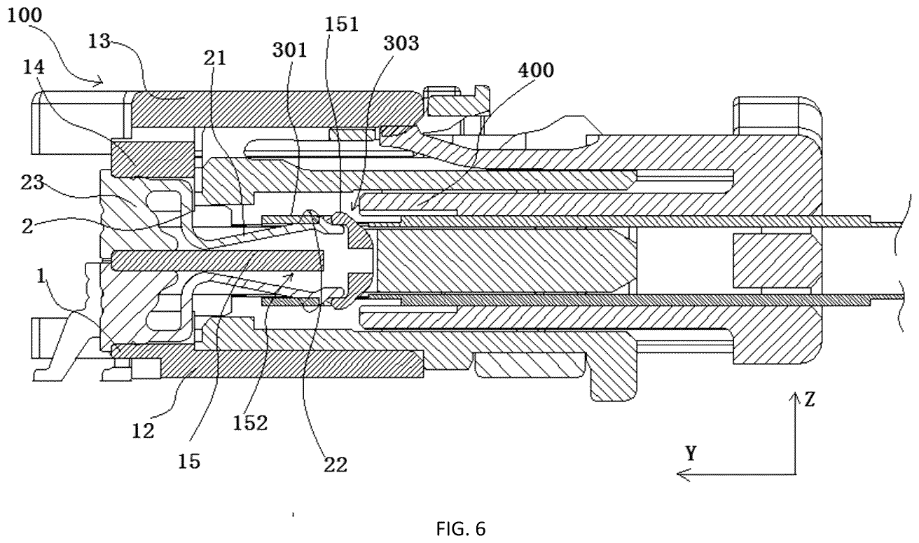

Referring in connection to FIGS. 4 and 6, in the longitudinal direction Y, the tongue 15 is provided with a first channel 152 for installing the first terminal 2, and a second channel 153 for installing the second terminal 3. The protruding portion 151 is provided at an end of the first channel 152. The first contact portion 22 of the first terminal 2 is adjacent to the protruding portion 151, and the first contact portion 22 protrudes towards the top 13 or the bottom 12 in a manner elastically extending/retracting within the first channel 152. In some embodiments, the projection of the vertex of the protruding portion 151 on the tongue surface 150 and the projection of the vertex of the first contact portion 22 on the tongue surface 150 are on the same straight line.

The first terminal 2 includes a first fixing portion 23 fixedly connected to the rear 14. The first elastic arm 21 is formed by extending from the first fixing portion 23, being initially bent once towards the tongue 15 in the thickness direction Z, and then being bent a second time towards the top 13 or the bottom 12. When the flexible cable 300 is not pressed by the extension 400 in the thickness direction Z, the end of the first elastic arm 21 abuts against a bottom of the protruding portion 151.

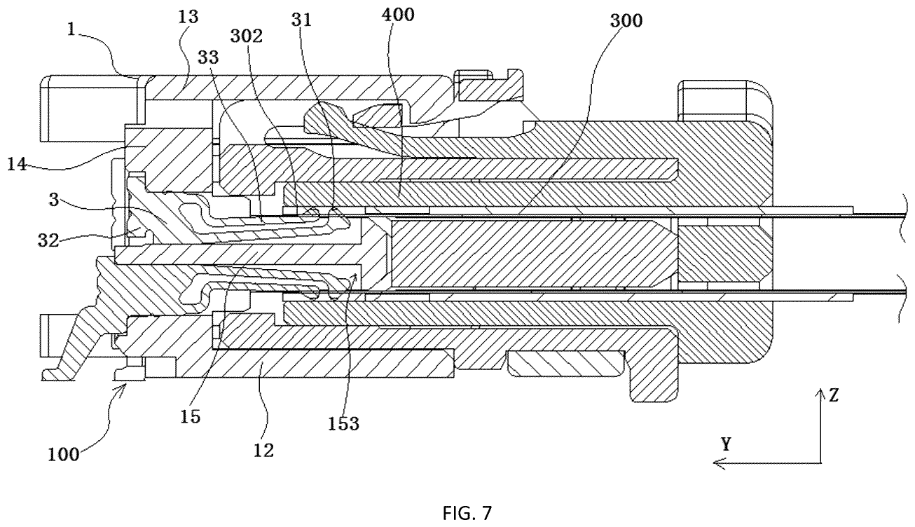

Referring in connection to FIGS. 4 and 7, the second channels 153 are located between the first channels 152. In the embodiment, the tongue 15 is provided with three first channels 152. Two of the three first channels 152 are close to the sides 11, and the other first channel 152 is disposed in the middle of the tongue 15 in the longitudinal direction Y. In other embodiments, the number and length of the first channels 152 can be optimized according to the width of the flexible cable 300. For example, only the two first channels 152 near the sides 11 may be provided, or four or more first channels 152 may be provided. The second channels 153 are located between the first channels 152 on both sides, that is, the first channels 152 separate or surround the second channels 153 in the transverse direction X.

The second terminal 3 includes a second contact portion 31, a second fixing portion 32, and a second elastic arm 33. The second elastic arm 33 is formed by extending from the second fixing portion 32 and being bent. The second contact portion 31 is disposed on the second elastic arm 33, and the second contact portion 31 protrudes towards the top 13 or the bottom 12 in a manner elastically extending/retracting within the second channel 153. In the embodiment, the second terminals 3 are arranged in upper and lower rows. Furthermore, the second terminal 3 is of a dual-elastic-arm dual-contact-point structure, meaning that each second terminal 3 has two second elastic arms 33 and two second contact portions 31.

Further referring to FIGS. 6 and 7, during the process where the insertion portion 301 of the flexible cable 300 passes through the opening 16 and is installed on the tongue 15, the insertion portion 301 is guided forward by the protruding portion 151 and lifted by the first contact portion 22, which has the greatest protruding portion height relative to the tongue surface 150. After the insertion portion 301 reaches the predetermined position, the extension 400 is further inserted into the cavity 10 in the longitudinal direction Y and pushes the insertion portion 301 to press against the first contact portion 22 in the thickness direction Z. The protruding portion 151 of the tongue 15 passes into and connects with the through hole 303 for limiting, and the contact pads 302 of the flexible cable 300 abut against the second contact portion 31 to achieve electrical contact connection.

With the receptacle connector provided by the embodiment, during the connection with the flexible cable, it is required that the contact pads contact the second terminal only after the flexible cable is installed in place and the extension is pushed forward in the longitudinal direction. This can avoid scratching and wear of the plating layer of the contact pad during insertion/removal and reduce the introduction of foreign objects that could damage the contact pads.

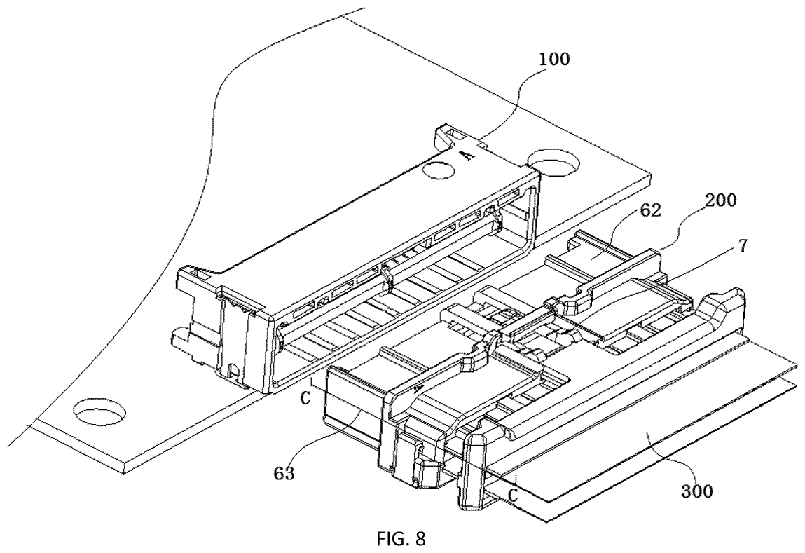

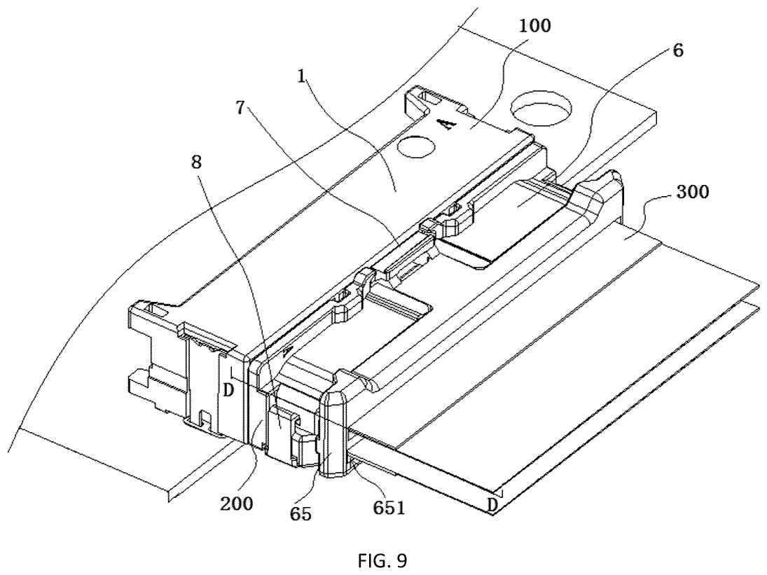

On the basis of FIGS. 1-7, referring to FIGS. 8-12, this embodiment provides a connector assembly, comprising the receptacle connector 100 of Embodiment 1 and a plug connector 200 connected with the receptacle connector 100 in a mating manner. The flexible cable 300 is installed in the plug connector 200 and is inserted into the receptacle connector 100 through the plug connector 200, achieving electrical contact connection between the contact pads 302 of the flexible cable 300 and the second contact portions 31 of the second terminals 3.

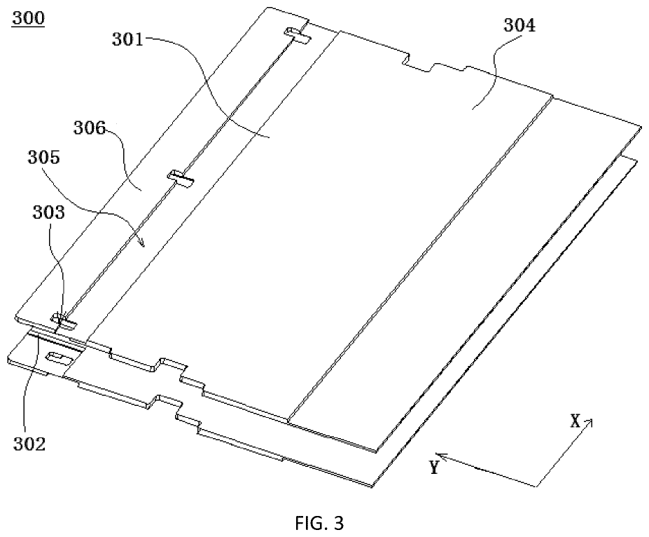

Further referring to FIG. 3, in the flexible cable 300, the insertion portion 301 is provided with a reinforcing layer 304 and a thinner portion 305. The reinforcing layer 304 is a plate-like or laminated film structure used to enhance the structural strength of the insertion portion 301 and facilitate insertion into the cavity 10 of the receptacle connector 100. In the embodiment, the reinforcing layer 304 is disposed on one face of the flexible cable 300 facing the bottom 12 or the top 13, while the contact pads 302 are disposed on the face of the flexible cable 300 facing the tongue 15.

It should be noted that the thinner portion 305 is provided on the reinforcing layer 304, ensuring that the insertion portion 301 has structural strength while also having good flexibility, facilitating the leading end 306 of the insertion portion 301 to be lifted by the first contact portion 22 and reach the installation position during the insertion process.

Further, the thinner portion 305 comprises a recess formed by recessing in the thickness direction Z from the reinforcing layer 304. In some embodiments, the recess may be configured as a single notch or a plurality of independent notches, where the plurality of independent notches are not communicated with each other. In some other embodiments, the recess is a continuous notch penetrating the insertion portion 301 in the transverse direction X. Based on the continuous slot structure, the insertion portion 301 is more easily guided by the protruding portion 151 as a whole and lifted by the first contact portion 22 during the process of being inserted into the cavity 10 and installed on the tongue 15, avoiding scratching and wear of the contact pads.

The through hole 303, which serves an avoidance function, is a strip-shaped hole or an elliptical hole provided along the longitudinal direction Y. Part of the through hole 303 is located at the leading end 306, and part of the through hole is located in the recess of the thinner portion 305.

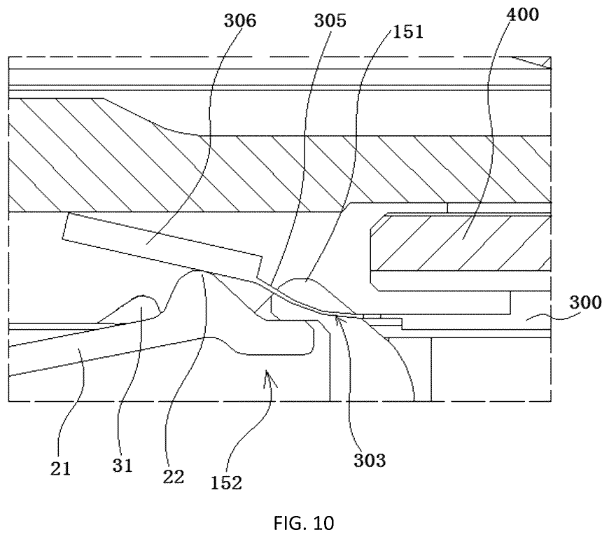

As shown in FIG. 10, after the leading end 306 is guided by the protruding portion 151 and lifted by the first contact portion 22, the vertex of the protruding portion 151 first passes into the part of the through hole located at the leading end 306, and then passes into the part of the through hole located in the thinner portion 305. In this case, the leading end 306 can be pressed against the first contact portion 22 by pushing the extension 400, and the first elastic arm 21 undergoes elastic deformation, and the end of the first elastic arm 21, which originally abutted against the bottom of the protruding portion 151, moves towards the first channel 152, and the protruding portion 151 completely passes into the through hole 303 for avoidance and limiting.

The plug connector 200 includes a housing 6, a first locking member 7, and a second locking member 8. The housing 6 includes a bottom 61 and a top 62 oppositely arranged in the thickness direction Z, a pair of sides 63 oppositely arranged in the transverse direction X, and a spacer 64. The sides 63 on both sides and the spacer 64, together with the top 62 above, surround to form a slot 60, or the sides 63 on both sides and the spacer 64, together with the bottom 61 below, surround to form a slot 60. That is, two slots 60 are formed within the cavity of the housing 6 by being separated by the spacer 64, for pre-installing the extension 400 and the flexible cable 300. The top 62 comprises a first locking space 621, and the bottom comprises a second locking space 611.

The first locking member 7 is pre-installed in the first locking space 621. The first locking member 7 is configured to cooperate and connect with the top 13 of the receptacle connector 100.

The second locking member 8 is inserted and installed in the second locking space 611 along the thickness direction Z. The second locking member 8 is configured to limit the flexible cable 300 in the housing 6.

Further, the plug connector 200 further comprises a body 65. The body 65 is provided with an slit 651 connected with the slot 60. The flexible cable 300 passes through the slit 651 and is inserted into the slot 60.

The extension 400, the first locking member 7, and the body 65 can be separate structures or an integrated structure. In some embodiments, the extension 400, the first locking member 7, and the body 65 are separate structures. The extension 400 and the first locking member 7 are first inserted and installed into the slot 60 and the first locking space 621, respectively. The body 65 and the housing 6 have a preset push-in distance. The flexible cable 300 passes through the slit 651 and is inserted into the slot 60, and is limited by the second locking member 8 in the thickness direction. The flexible cable 300 is flatly pressed by the extension 400 and connected to the spacer 64, but the extension 400 can move forward relative to the flexible cable 300.

In some embodiments, the extension 400, the first locking member 7, and the body 65 form an integral component 500. In the integral component 500, the extension 400 and the first locking member 7 extend from the same side of the body 65. During installation, the integral component 500 is inserted into the housing 6. In this case, the extension 400 and the first locking member 7 move synchronously and are inserted and installed into the slot 60 and the first locking space 621, respectively. As shown in FIG. 8, the slit 651 of the body 65 and the slot 60 have a certain distance before being fully communicated. The flexible cable 300 passes through the slit 651 and is inserted into the slot 60.

Regarding the connection structure of the extension 400 and the side 63, the side 63 is provided with a limiting block 631 protruding towards the slot 60. The limiting block 631 is provided with a guiding portion 632 and a stopping portion 633. The guiding portion 632 is closer to the body 65 than the stopping portion 633. The guiding portion 632 is a curved surface structure, and the stopping portion 633 is a right-angle structure.

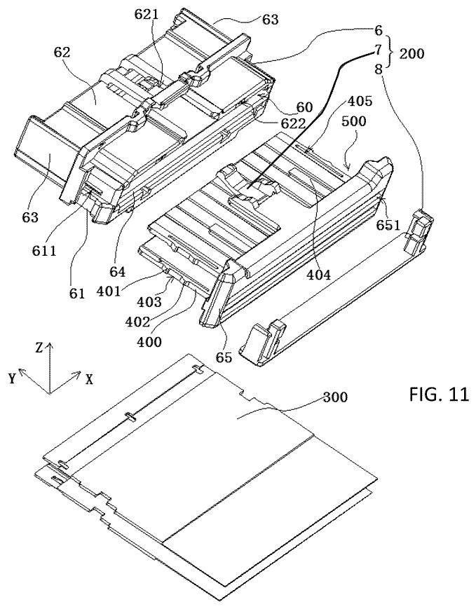

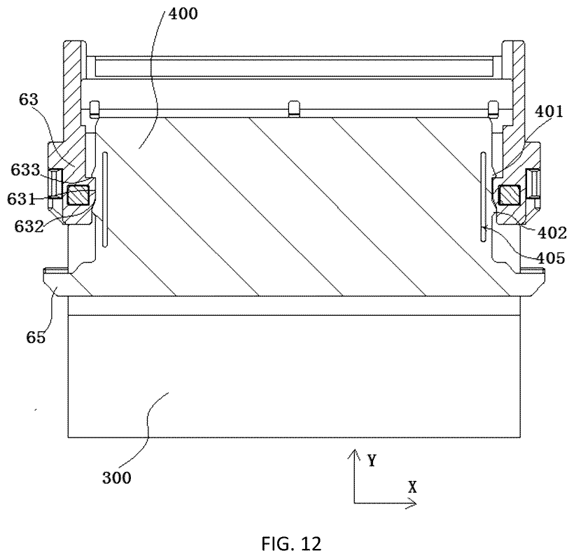

Correspondingly, referring in connection to FIGS. 11 and 12, the extension 400 is provided on its side wall with a first protrusion 401, a second protrusion 402, and a gap 403. The second protrusion 402 is closer to the body 65 than the first protrusion 401. The second protrusion 402 is a curved surface structure, and the first protrusion 401 is a right-angle structure. The gap 403 is provided between the first protrusion 401 and the second protrusion 402, and its slot shape adapts to the shape of the limiting block 631. When the extension 400 is pre-locked in the housing 6, the limiting block 631 snaps into engagement with the gap 403, and the first protrusion 401 is limited at the stopping portion 633. Since both the first protrusion 401 and the stopping portion 633 have right-angle structures, the first protrusion 401 cannot be fallen off from the slot in the longitudinal direction Y. In this case, the second protrusion 402 abuts against the guiding portion 632. A front end of the extension 400 reaches the thinner portion of the flexible cable 300 but has not reached the leading end.

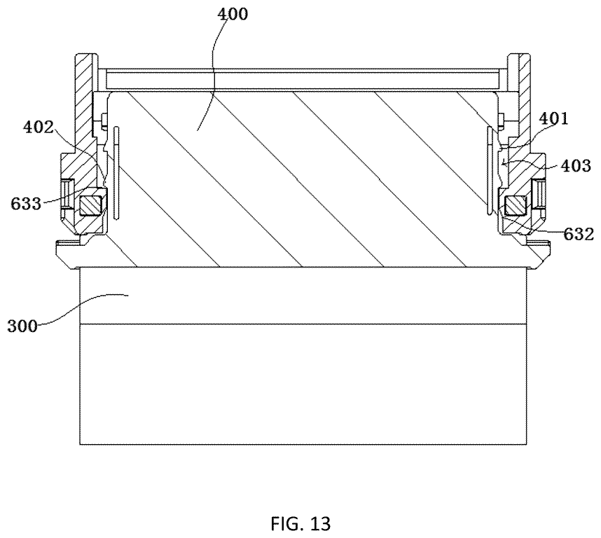

Referring in connection to FIGS. 6-7, and FIGS. 12 and 13, when the extension 400 moves forward in the longitudinal direction Y and pushes the leading end 306 of the flexible cable 300 in the thickness direction Z to press the first contact portion 22, the gap 403 moves away from the limiting block 631, the second protrusion 402 passes by the guiding portion 632, and is finally limited at the stopping portion 633. The front end of the extension 400 reaches the leading end of the flexible cable 300. Upon successful insertion, there is tactile and auditory feedback. It should be appreciated some figures may include artifacts resulting from the computer-aided model. For example, the first contact portions 22 may appear to pass through the insert portion 301.

In the plug connector 200, the leading end 306 of the flexible cable 300 is recessed inside the housing 6, preventing accidental contact and impact.

Additionally, the extension 400 comprises a reinforcing rib 404. In the thickness direction Z, the reinforcing rib 404 faces the bottom 61 or the top 62. Moreover, the reinforcing rib 404 is connected to the body 65 and extends in the longitudinal direction Y, preventing deformation of the extension 400 in the thickness direction. Correspondingly, the housing 6 is provided with a guiding groove 622 on the top 62. The guiding groove 622 and the reinforcing rib 404 cooperate with each other, providing a limiting and guiding function. The extension 400 comprises a groove 405 in the longitudinal direction Y at a position adjacent to the first protrusion 401 and the second protrusion 402, facilitating elastic deformation of the first protrusion 401 and the second protrusion 402 when passing the limiting block 631.

In the receptacle connector 100, the top 13 comprises the locking slot 131 facing the cavity 10. Since the extension 400, the first locking member 7, and the body 65 are integrally formed as integral component 500, when the extension 400 moves, the first locking member 7 is configured to move synchronously with the extension 400 and is inserted and fixed into the locking slot 131.

With the connector assembly provided in the embodiment, the receptacle connector and the plug connector are cooperatively connected with each other, and the flexible cable has a thinner portion which not only facilitates smooth insertion into the cavity but also aids in being lifted by the first contact portion in the thickness direction and ultimately being pressed by the extension, enabling the contact pads to electrically contact and connect the second contact portion, thereby enhancing the connection stability between the flexible cable and the second terminal and improving transmission efficiency.

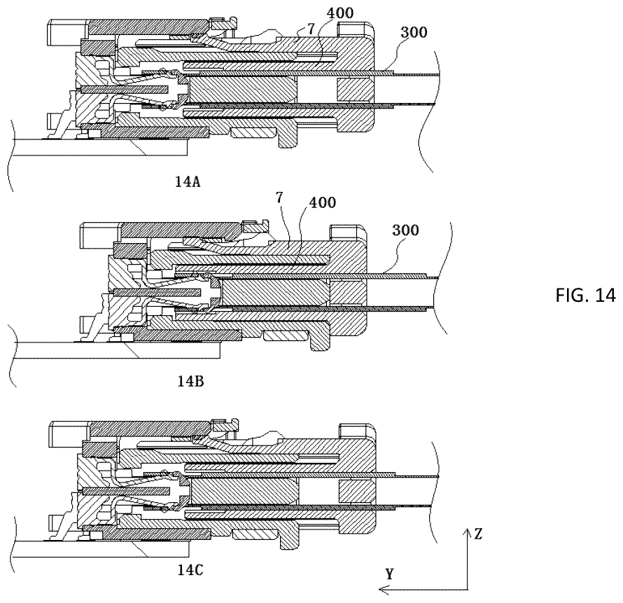

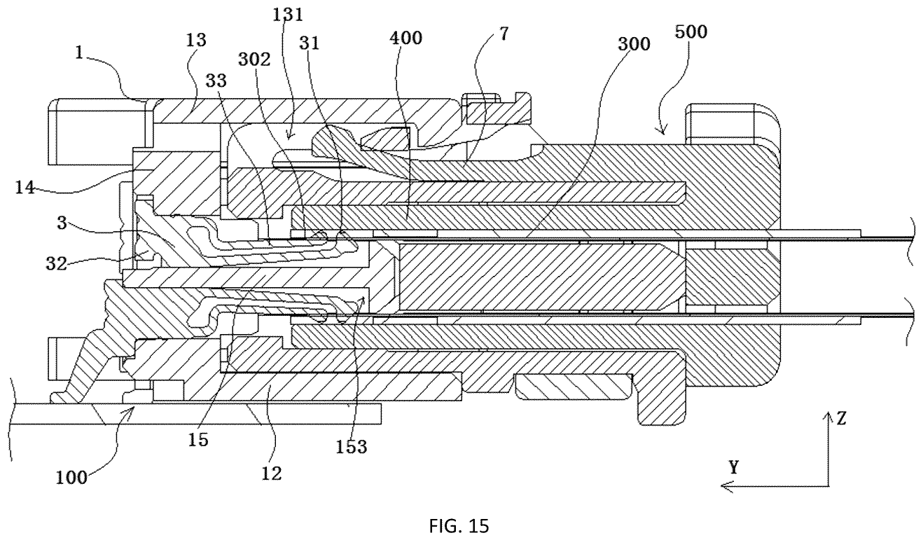

Based on FIGS. 1-13, and referring to FIGS. 14 and 15, this embodiment explains the hot insertion/removal operation of the connector assembly.

As shown in portion A of FIG. 14, the integral component 500 is inserted into the housing 6. The extension 400 and the first locking member 7 are first inserted and installed into the slot 60 and the first locking space 621, respectively. The body 65 and the housing have a certain distance. The flexible cable 300 is inserted into the slot 60 through the slit and is locked in the thickness direction by the second locking member 8. The flexible cable 300 is flatly pressed by the extension 400 and connected to the spacer 64.

Next, the plug connector 200 is inserted into the cavity 10 of the receptacle connector 100. The insertion portion 301 of the flexible cable 300 passes through the opening 16 and is installed on the tongue 15. The leading end 306 of the insertion portion 301 is guided forward by the protruding portion 151. The thinner portion 305 provided in the reinforcing layer 304 ensures that the insertion portion 301 has structural strength while also having good flexibility, facilitating the leading end 306 of the insertion portion 301 to be guided forward by the protruding portion 151 and then lifted by the first contact portion 22 to reach the installation position. The first locking member enters the locking slot for pre-locking.

Referring to FIG. 10, the second contact portion 31 of the second terminal 3 is not in contact with the contact pads of the flexible cable.

In portion B of FIG. 14, at the pressing position of the integral component, the extension 400 is further inserted into the cavity 10 in the longitudinal direction Y by pushing the extension 400 and the first locking member 7 in the longitudinal direction Y, such that the leading end 306 can be pressed against the first contact portion 22, and the first elastic arm 21 undergoes elastic deformation, and the end of the first elastic arm 21, which originally abutted against the bottom of the protruding portion 151, moves towards the first channel 152. The protruding portion 151 completely passes into the through hole 303 for avoidance and limiting. The first locking member completely enters the locking slot, locking the receptacle connector and the plug connector together.

Correspondingly, referring to FIG. 15, the leading end 306 of the insertion portion 301 moves closer to the tongue 15, and the contact pads 302 of the flexible cable 300 abut against the second contact portion 31 to achieve electrical contact connection.

In portion C of FIG. 14, even when powered on, the first locking member and the extension are partially withdrawn from the cavity by pulling out the integral component in the longitudinal direction Y. In this case, the first elastic arm moves towards the direction of the tongue, lifting the insertion portion, separating the contact pads of the flexible cable from the second contact portion. That is, the plug connector and the receptacle connector can be connected and disconnected while powered on, thereby achieving hot insertion/removal.

Various aspects are described in this disclosure, which include, but are not limited to, the following aspects:
1. An electrical connector configured for a flexible cable (e.g., 300), comprising: a housing (e.g., 6) comprising a top (e.g., 62) comprising a locking space (e.g., 621), a spacer (e.g., 64), and a slot (e.g., 60) between the top and the spacer; and an integral component (e.g., 500) comprising a body (e.g., 65), an extension (e.g., 400) extending from the body into the slot of the housing and configured to press the flexible cable into contact with conductive elements of a mating connector, and a locking member (e.g., 7) extending from the body into the locking space of the top of the housing, the integral component capable of moving from a prelocked position to a locked position when the electrical connector is mated with the mating connector so as to restrain movements between the electrical connector and the mating connector.
2. The electrical connector of aspect 1 or any other aspect, wherein the body (e.g., 65) of the integral component (e.g., 500) comprises a slit (e.g., 651) aligned with the slot (e.g., 60) such that the flexible cable (e.g., 300) passes through the slit of the integral component into the slot of the housing (e.g., 6).
3. The electrical connector of aspect 1 or any other aspect, wherein the extension (e.g., 400) is configured to secure the flexible cable (e.g., 300) between the extension and the spacer (e.g., 64).
4. The electrical connector of aspect 1 or any other aspect, wherein: the housing (e.g., 6) comprises a side (e.g., 63) having a limiting block (e.g., 631) protruding into the slot (e.g., 60); the extension (e.g., 400) of the integral component (e.g., 500) comprises first and second protrusions (e.g., 401, 402) protruding toward the side of the housing, and a gap (e.g., 403) between the first and second protrusions; and the integral component is configured to receive the limiting block of the housing in the gap at the prelocked position and to move past the limiting block in a mating direction at the locked position.
5. The electrical connector of aspect 2 or any other aspect, wherein: the locking space is a first locking space (e.g., 621); the locking member is a first locking member (e.g., 7); the housing (e.g., 6) comprises a bottom (e.g., 61) comprising a second locking space (e.g., 611); and the electrical connector comprises a second locking member (e.g., 8) disposed in the second locking space and configured for restraining movements between the flexible cable (e.g., 300) and the housing.
6. The electrical connector of aspect 5 or any other aspect, wherein: the slot (e.g., 60) between the top (e.g., 62) and the spacer (e.g., 64) is a first slot; and the housing (e.g., 6) comprises a second slot between the bottom (e.g., 61) and the spacer and configured for receiving another flexible cable (e.g., 300).
7. The electrical connector of aspect 6 or any other aspect, wherein: the slit (e.g., 651) is a first slit aligned with the first slot; the body (e.g., 65) of the integral component (e.g., 500) comprises a second slit aligned with the second slot such that the another flexible cable (e.g., 300) passes through the second slit of the integral component into the second slot of the housing (e.g., 6).
8. The electrical connector of aspect 7 or any other aspect, wherein: the extension (e.g., 400) is a first extension extending from the body (e.g., 65) into the first slot of the housing (e.g., 6); the integral component (e.g., 500) comprises a second extension extending from the body into the second slot of the housing; and the second extension is configured to secure the another flexible cable (e.g., 300) between the second extension and the spacer (e.g., 64).
9. The electrical connector of aspect 1 or any other aspect, comprising: the flexible cable (e.g., 300) comprising an insertion portion (e.g., 301) disposed in the slot (e.g., 60), the insertion portion comprising a reinforcing layer (e.g., 304) extending to a leading end (e.g., 306), the reinforcing layer comprising a thinner portion (e.g., 305), the insertion portion comprising one or more through holes (e.g., 303) extending in both the leading end and the thinner portion.
10. The electrical connector of aspect 4 or any other aspect, wherein: the extension (e.g., 400) comprises a rib (e.g., 404) facing the top (e.g., 62), and a groove (e.g., 405) adjacent the first and second protrusions (e.g., 401, 402), both the rib and the groove configured to engage the mating connector.
11. An electrical connector for connecting with a flexible cable (e.g., 300), comprising: a housing (e.g., 1) comprising a cavity (e.g., 10) and a tongue (e.g., 15) disposed in the cavity; one or more first terminals (e.g., 2) disposed in the tongue, each of the one or more first terminals comprising a first elastic arm (e.g., 21) and a first contact portion (e.g., 22) disposed on the first elastic arm; and a plurality of second terminals (e.g., 3) each comprising a second contact portion (e.g., 31), wherein at rest states, the first contact portions of the one or more first terminals are disposed above the second contact portions of the plurality of second terminals such that the one or more first terminals engage the flexible cable prior to the plurality of second terminals.
12. The electrical connector of aspect 11 or any other aspect, wherein: the tongue (e.g., 15) of the housing (e.g., 1) comprises one or more protruding portions (e.g., 151) offset from the first contact portions (e.g., 22) of the one or more first terminals (e.g., 2) such that the one or more protruding portions of the tongue of the housing engage the flexible cable (e.g., 300) prior to the one or more first terminals.
13. The electrical connector of aspect 12 or any other aspect, wherein: the tongue (e.g., 15) of the housing (e.g., 1) comprises one or more first channels (e.g., 152) configured for receiving respective first terminals (e.g., 2); and the one or more protruding portions (e.g., 151) are disposed at distal ends of respective first channels.
14. The electrical connector of aspect 13 or any other aspect, wherein: at the rest states, the first elastic arms (e.g., 21) of the one or more first terminals (e.g., 2) abut respective protruding portions (e.g., 151).
15. The electrical connector of aspect 13 or any other aspect, wherein: the tongue (e.g., 15) comprises a plurality of second channels (e.g., 153) configured for receiving respective second terminals (e.g., 3).
16. A method of operating a flexible cable (e.g., 300) with respect to an electrical connector, the electrical connector comprising a tongue (e.g., 15), one or more first terminals (e.g., 2) having first contact portions (e.g., 22) disposed above the tongue, and a plurality of second terminals (e.g., 3) having second contact portions (e.g., 31) disposed above the tongue and below the first contact portions of the one or more first terminals, the method comprising: engaging a leading end (e.g., 306) of the flexible cable with the first contact portions of the one or more first terminals such that contact pads (e.g., 302) of the flexible cable are separated from the second contact portions of the plurality of second terminals; and applying a pressing force to the flexible cable toward the tongue such that the contact pads of the flexible cable make contact with respective second contact portions of the plurality of second terminals.
17. The method of aspect 16 or any other aspect, comprising: engaging the leading end (e.g., 306) of the flexible cable (e.g., 300) with protruding portions (e.g., 151) of the tongue (e.g., 15) prior to engaging the leading end of the flexible cable with the first contact portions (e.g., 22) of the one or more first terminals (e.g., 2) to reduce risks of damaging the contact pads (e.g., 302) of the flexible cable.
18. The method of aspect 17 or any other aspect, comprising: inserting the flexible cable (e.g., 300) until the protruding portions (e.g., 151) enter into respective through holes (e.g., 303) of the flexible cable.
19. The method of aspect 16 or any other aspect, comprising: removing the pressing force from the flexible cable (e.g., 300) such that the one or more first terminals (e.g., 2) lift up the flexible cable to disconnect the contact pads (e.g., 302) of the flexible cable from the respective second contact portions (e.g., 31) of the plurality of second terminals (e.g., 3).
20. The method of aspect 16 or any other aspect, comprising: engaging a locking member (e.g., 7) with the electrical connector while applying, via an extension (e.g., 400) integrated with the locking member, the pressing force to the flexible cable (e.g., 300) toward the tongue (e.g., 15).
21. A receptacle connector (e.g., 100) for connecting with a flexible cable (e.g., 300), comprising: a housing (e.g., 1) comprising a pair of sides (e.g., 11) oppositely arranged in a transverse direction (e.g., X), a bottom (e.g., 12) and a top (e.g., 13) oppositely arranged in a thickness direction (e.g., Z), as well as a rear (e.g., 14) and a tongue (e.g., 15), the bottom, the top, the sides and the rear collectively surrounding a cavity (e.g., 10) with an opening (e.g., 16), the tongue disposed in the cavity, and the tongue comprising a protruding portion (e.g., 151) near the opening; a first terminal (e.g., 2) disposed in the tongue, the first terminal comprising a first elastic arm (e.g., 21) and a first contact portion (e.g., 22) disposed on the first elastic arm; and a second terminal (e.g., 3) disposed between the first terminals, the second terminal comprising a second contact portion (e.g., 31), wherein: the tongue comprises a tongue surface (e.g., 150), and distances from vertexes of the protruding portion, the first contact portion and the second contact portion to the tongue surface are respectively H₁, H₂, H₃ which satisfies the relationship: H₂≥H₁>H₃; the flexible cable is configured to be disposed in the receptacle connector via an extension (e.g., 400); the flexible cable comprises an insertion portion (e.g., 301) comprising contact pads (e.g., 302) and a through hole (e.g., 303); the insertion portion is configured to pass through the opening and to be disposed on the tongue after being lifted by the first contact portion; the extension is configured to be inserted into or removed from the cavity in a longitudinal direction (e.g., Y), and to press the insertion portion against the first contact portion in the thickness direction; and the protruding portion is configured to pass into the through hole, and the second contact portion is configured to electrically connect with the contact pad.
22. The receptacle connector of aspect 21 or any other aspect, wherein: the tongue (e.g., 15) extends from the rear (e.g., 14) towards the opening (e.g., 16); in the longitudinal direction (e.g., Y), the tongue comprises a first channel (e.g., 152) configured for receiving the first terminal (e.g., 2); and the protruding portion (e.g., 151) is disposed at an end of the first channel, the first contact portion (e.g., 22) is adjacent to the protruding portion and protrudes towards the top (e.g., 13) or the bottom (e.g., 12) in a manner elastically extending/retracting within the first channel.
23. The receptacle connector of aspect 22 or any other aspect, wherein: the first terminal (e.g., 2) further comprises a first fixing portion (e.g., 23) fixedly connected to the rear (e.g., 14); the first elastic arm (e.g., 21) extends from the first fixing portion, initially bent once towards the tongue (e.g., 15) in the thickness direction (e.g., Z), and then bent a second time towards the top (e.g., 13) or the bottom (e.g., 12); and when the flexible cable (e.g., 300) is not pressed in the thickness direction, an end of the first elastic arm abuts against a bottom of the protruding portion (e.g., 151).
24. The receptacle connector of aspect 22 or any other aspect, wherein: the tongue (e.g., 15) further comprises a second channel (e.g., 153) configured for receiving the second terminal (e.g., 3), the second channel disposed between the first channels (e.g., 152); and the second terminal comprises a second fixing portion (e.g., 32) and a second elastic arm (e.g., 33) extending from the second fixing portion and bent; and the second contact portion (e.g., 31) is disposed on the second elastic arm, and the second contact portion protrudes towards the top (e.g., 13) or the bottom (e.g., 12) in a manner elastically extending/retracting within the second channel.
25. A connector assembly comprising: the receptacle connector (e.g., 100) of any one of aspects 21-24; and a plug connector (e.g., 200) configured to mate with receptacle connector, the flexible cable (e.g., 300) disposed in the plug connector, wherein the insertion portion (e.g., 301) comprises a reinforcing layer (e.g., 304) having a thinner portion (e.g., 305).
26. The connector assembly of aspect 25 or any other aspect, wherein: the thinner portion (e.g., 305) comprises a recess comprising a single notch, a plurality of independent notches, or a continuous notch penetrating the insertion portion (e.g., 301) in the transverse direction (e.g., X).
27. The connector assembly of aspect 26 or any other aspect, wherein: the through hole (e.g., 303) is at least partially located at a leading end (e.g., 306) of the insertion portion (e.g., 301), and at least partially located in the thinner portion (e.g., 305).
28. The connector assembly of aspect 27 or any other aspect, wherein the plug connector (e.g., 200) comprises: a housing (e.g., 6) comprising a bottom (e.g., 61) and a top (e.g., 62) oppositely arranged in the thickness direction (e.g., Z), a pair of sides (e.g., 63) oppositely arranged in the transverse direction (e.g., X), and a spacer (e.g., 64), the sides and the spacer, together with the top or bottom, respectively surround to form a slot (e.g., 60), the extension (e.g., 400) extending in the slot, the top and the bottom respectively comprising a first locking space (e.g., 621) and a second locking space (e.g., 611); a first locking member (e.g., 7) pre-installed in the first locking space and configured for connecting with the top (e.g., 13) of the housing (e.g., 1) of the receptacle connector (e.g., 100); and a second locking member (e.g., 8) which is inserted and installed in the second locking space along the thickness direction and configured for limiting the flexible cable (e.g., 300) in the housing of the plug connector.
29. The connector assembly of aspect 28 or any other aspect, wherein: the plug connector (e.g., 200) further comprises a body (e.g., 65) having a slit (e.g., 651) connected with the slot (e.g., 60); and the flexible cable (e.g., 300) is configured to pass through the slit and be inserted into the slot.
30. The connector assembly of aspect 29 or any other aspect, wherein: the extension (e.g., 400), the first locking member (e.g., 7), and the body (e.g., 65) form an integral component (e.g., 500); and the extension and the first locking member extend from the same side of the body.
31. The connector assembly of aspect 30 or any other aspect, wherein: the side (e.g., 63) of the housing (e.g., 6) of the plug connector (e.g., 200) comprises a limiting block (e.g., 631) protruding towards the slot (e.g., 60), and the limiting block comprises a guiding portion (e.g., 632) and a stopping portion (e.g., 633); and the extension (e.g., 400) comprises a first protrusion (e.g., 401) and a second protrusion (e.g., 402) protruding from a side wall, as well as a gap (e.g., 403) between the first protrusion and the second protrusion; and when the extension is pre-locked in the housing of the plug connector, the limiting block snaps into engagement with the gap, and the first protrusion is limited at the stopping portion.
32. The connector assembly of aspect 31 or any other aspect, wherein: when the extension (e.g., 400) moves forward in the longitudinal direction (e.g., Y) and pushes the leading end (e.g., 306) of the flexible cable (e.g., 300) in the thickness direction (e.g., Z) to press the second contact portion (e.g., 31), the second protrusion (e.g., 402) passes by the guiding portion (e.g., 632) and is finally limited at the stopping portion (e.g., 633).
33. The connector assembly of aspect 31 or any other aspect, wherein: the extension (e.g., 400) comprises a reinforcing rib (e.g., 404) facing the top (e.g., 62) or the bottom (e.g., 61), and the reinforcing rib is connected to the body (e.g., 65) and extends in the longitudinal direction (e.g., Y); the extension comprises a groove (e.g., 405) in the longitudinal direction at a position adjacent to the first protrusion (e.g., 401) and the second protrusion (e.g., 402); and the top (e.g., 13) of the housing (e.g., 1) of the receptacle connector (e.g., 100) comprises a locking slot (e.g., 131) facing the cavity (e.g., 10), and the first locking member (e.g., 7) is configured to move synchronously with the extension and is inserted and fixed in the locking slot.

Having thus described several aspects of several embodiments, it is to be appreciated that various alterations, modifications, and improvements will readily occur to those skilled in the art. Such alterations, modifications, and improvements are intended to be part of this disclosure and are intended to be within the spirit and scope of the invention. While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art.

As an example, although many creative aspects have been described above with reference to right angle connectors, it should be understood that the aspects of the present disclosure are not limited to these. Any one of the creative features, whether alone or combined with one or more other creative features, can also be used for other types of electrical connectors, such as vertical connectors, etc.

Further, though some advantages of the present invention may be indicated, it should be appreciated that not every embodiment of the invention will include every described advantage. Some embodiments may not implement any features described as advantageous. Accordingly, the foregoing description and drawings are by way of example only.

Also, the technology described may be embodied as a method, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used, should be understood to control over dictionary definitions, definitions in documents incorporated by reference, and/or ordinary meanings of the defined terms.

It should be noted that the terms used herein are for describing specific embodiments, and are not intended to limit the exemplary embodiments according to the present application. As used herein, an expression of a singular form includes an expression of a plural form unless otherwise indicated. In addition, it should also be understood that when the terms “including” and/or “comprising” are used herein, it indicates the presence of features, steps, operations, parts, components and/or combinations thereof.

The indefinite articles “a” and “an,” as used in the specification and in the claims, unless clearly indicated to the contrary, should be understood to mean “at least one.”

In the claims, as well as in the specification above, all transitional phrases such as “comprising,” “including,” “carrying,” “having,” “containing,” “involving,” “holding,” “composed of,” and the like are to be understood to be open-ended, e.g., to mean including but not limited to. For example, a process, method, system, product or device that contains a series of steps or units need not be limited to those steps or units that are clearly listed, instead, it may include other steps or units that are not clearly listed or are inherent to these processes, methods, products or devices. Only the transitional phrases “consisting of” and “consisting essentially of” shall be closed or semi-closed transitional phrases, respectively.

The claims should not be read as limited to the described order or elements unless stated to that effect. It should be understood that various changes in form and detail may be made by one of ordinary skill in the art without departing from the spirit and scope of the appended claims. All embodiments that come within the spirit and scope of the following claims and equivalents thereto are claimed.

In the claims, as well as in the specification above, use of ordinal terms such as “first,” “second,” “third,” etc. does not by itself connote any priority, precedence, or order of one element over another or the temporal order in which acts of a method are performed, but are used merely as labels to distinguish one element having a certain name from another element having a same name (but for use of the ordinal term) to distinguish the elements.

What is claimed is:

1. An electrical connector configured for a flexible cable, comprising:
a housing comprising a top comprising a locking space, a spacer, and a slot between the top and the spacer; and
an integral component comprising a body, an extension extending from the body into the slot of the housing and configured to press the flexible cable into contact with conductive elements of a mating connector, and a locking member extending from the body into the locking space of the top of the housing, the integral component being movably coupled to the housing so as to move from a prelocked position to a locked position when the electrical connector is mated with the mating connector so as to restrain movements between the electrical connector and the mating connector.

2. The electrical connector of claim 1, wherein:
the body of the integral component comprises a slit aligned with the slot such that the flexible cable passes through the slit of the integral component into the slot of the housing.

3. The electrical connector of claim 2, wherein:
the extension is configured to secure the flexible cable between the extension and the spacer.

4. The electrical connector of claim 1, wherein:
the housing comprises a side having a limiting block protruding into the slot;
the extension of the integral component comprises first and second protrusions protruding toward the side of the housing, and a gap between the first and second protrusions; and
the integral component is configured to receive the limiting block of the housing in the gap at the prelocked position and to move pass the limiting block in a mating direction at the locked position.

5. The electrical connector of claim 2, wherein:
the locking space is a first locking space;
the locking member is a first locking member;
the housing comprises a bottom comprising a second locking space; and
the electrical connector comprises a second locking member disposed in the second locking space and configured for restraining movements between the flexible cable and the housing.

6. The electrical connector of claim 5, wherein:
the slot between the top and the spacer is a first slot; and
the housing comprises a second slot between the bottom and the spacer and configured for receiving another flexible cable.

7. The electrical connector of claim 6, wherein:
the slit is a first slit aligned with the first slot;
the body of the integral component comprises a second slit aligned with the second slot such that the another flexible cable passes through the second slit of the integral component into the second slot of the housing.

8. The electrical connector of claim 7, wherein:
the extension is a first extension extending from the body into the first slot of the housing;
the integral component comprises a second extension extending from the body into the second slot of the housing; and
the second extension is configured to secure the another flexible cable between the second extension and the spacer.

9. The electrical connector of claim 1, comprising:
the flexible cable comprising an insertion portion disposed in the slot, the insertion portion comprising a reinforcing layer extending to a leading end, the reinforcing layer comprising a thinner portion, the insertion portion comprising one or more through holes extending in both the leading end and the thinner portion.

10. The electrical connector of claim 4, wherein:
the extension comprises a rib facing the top, and a groove adjacent the first and second protrusions, both the rib and the groove configured to engage the mating connector.

11. An electrical connector for connecting with a flexible cable, comprising:
a housing comprising a cavity and a tongue disposed in the cavity;
one or more first terminals disposed in the tongue, each of the one or more first terminals comprising a first elastic arm and a first contact portion disposed on the first elastic arm; and
a plurality of second terminals each comprising a second contact portion,
wherein at rest states, the first contact portions of the one or more first terminals are disposed above the second contact portions of the plurality of second terminals such that the one or more first terminals engage the flexible cable prior to the plurality of second terminals.

12. The electrical connector of claim 11, wherein:
the tongue of the housing comprises one or more protruding portions offset from the first contact portions of the one or more first terminals such that the one or more protruding portions of the tongue of the housing engage the flexible cable prior to the one or more first terminals.

13. The electrical connector of claim 12, wherein:
the tongue of the housing comprises one or more first channels configured for receiving respective first terminals; and
the one or more protruding portions are disposed at distal ends of respective first channels.

14. The electrical connector of claim 13, wherein:
at the rest states, the first elastic arms of the one or more first terminals abut respective protruding portions.

15. The electrical connector of claim 13, wherein:
the tongue comprises a plurality of second channels configured for receiving respective second terminals.

16. A method of operating a flexible cable with respect to an electrical connector, the electrical connector comprising a tongue, one or more first terminals having first contact portions disposed above the tongue, and a plurality of second terminals having second contact portions disposed above the tongue and below the first contact portions of the one or more first terminals, the method comprising:
engaging a leading end of the flexible cable with the first contact portions of the one or more first terminals such that contact pads of the flexible cable are separated from the second contact portions of the plurality of second terminals; and
applying a pressing force to the flexible cable toward the tongue such that the contact pads of the flexible cable make contact with respective second contact portions of the plurality of second terminals.

17. The method of claim 16, comprising:
engaging the leading end of the flexible cable with protruding portions of the tongue prior to engaging the leading end of the flexible cable with the first contact portions of the one or more first terminals to reduce risks of damaging the contact pads of the flexible cable.

18. The method of claim 17, comprising:
inserting the flexible cable until the protruding portions enter into respective through holes of the flexible cable.

19. The method of claim 16, comprising:
removing the pressing force from the flexible cable such that the one or more first terminals lift up the flexible cable to disconnect the contact pads of the flexible cable from the respective second contact portions of the plurality of second terminals.

20. The method of claim 16, comprising:
engaging a locking member with the electrical connector while applying, via an extension integrated with the locking member, the pressing force to the flexible cable toward the tongue.
